(19) United States
(12) Patent Application Publication
(10) Pub. No.: US 2022/0369606 A1
(43) Pub. Date: Nov. 24, 2022

(54) DYNAMIC BUOYANCY SYSTEM FOR SUBMERSIBLE PEN

(71) Applicant: Innovasea Systems, Inc., Boston, MA (US)

(72) Inventors: Thomas Selby, Boston, MA (US); Langley R. Gace, Bainbridge Island, WA (US); Mark Penner, Portsmouth, NH (US); Joseph L. Laughlin, Medford, OR (US)

(73) Assignee: Innovasea Systems, Inc., Boston, MA (US)

(21) Appl. No.: 17/750,206

(22) Filed: May 20, 2022

Related U.S. Application Data
(60) Provisional application No. 63/191,317, filed on May 20, 2021.

(51) Int. Cl. A01K 61/60

(52) U.S. Cl. CPC A01K 61/60

(57) ABSTRACT

A submersible aquaculture pen includes a mesh enclosure supported by an annular floatation collar in a body of water. A weight ring is suspended from the floatation collar with a first plurality of cables. A variable buoyancy assembly is operable to selectively transition the aquaculture pen between a floating configuration and a submerging configuration. The variable buoyancy assembly includes a plurality of connected bell jars that are closed at a top end and are open at a bottom end. An air supply system is configured to selectively inject a controlled amount of air into each of the connected bell jars.

### CROSS-REFERENCE TO RELATED APPLICATION

This application claims the benefit of Provisional Application No. 63/191,317 filed May 20, 2021, the disclosure of which is hereby incorporated by reference herein.

### BACKGROUND

Offshore (or open sea) aquaculture is a growing technology for the efficient, safe, and humane farming of fish wherein fish are raised in a more natural and healthful environment. Offshore aquaculture provides technologically advanced aquatic solutions for fish farming and is the future of sustainable seafood production. Fully integrated systems for offshore aquaculture may include heavy-duty submersible pens, hardware, and related equipment, intelligent sensors and environmental monitoring equipment, underwater feeding systems, and the like. Submersible and relocatable pens allow fish to grow and thrive in a protected enclosure. In particular, offshore aquaculture reduces the risks associated with overfishing indigenous fish populations, and efficiently addresses the increasing world demand for fish product at lower costs.

Offshore aquaculture fish pens are typically positioned in deeper and less-sheltered waters where ocean currents are relatively strong. Raising fish in an open sea environment is a relatively new approach to seawater aquaculture, and presents challenges associated with the exposed, high-energy conditions in the open sea. The fish pens are typically stocked with young fish, or fry, that are fed, raised, protected, and monitored until they reach maturity. Fish pens provide a healthy habitat and protected environment for the fish to mature. Similar fish pens may also be used for freshwater aquaculture, for example, in larger freshwater bodies of water.

A current industry standard fish pen, sometimes referred to as a surface pen, typically includes a cylindrical net open at the top and closed at the bottom. The surface pen is supported by a buoyancy ring, and is configured to remain at the water surface. Surface pens are therefore subject to potentially violent weather conditions. Submersible fish pens provide several advantages over surface fish pens, including the ability to protect the fish pen structure from damage from the high-energy inclement weather events, optimizing the health and well-being of the fish population, and avoiding or reducing the potential for damage to the fish pen structure from flotsam and the like.

An example of an open sea aquaculture fish pen is disclosed in U.S. Pat. Appl. Publ. No. 2021/0029974 A1, to Penner et al., which is hereby incorporated by reference. Penner et al. discloses a fish pen having a submerged intermediate net support ring located below the floatation assembly, with an intermediate jump net therebetween. Another example of an open sea fish pen systems is disclosed in U.S. Pat. No. 5,359,962, to Loverich, which is hereby incorporated by reference. Loverich discloses a mobile pen for growing fish or shellfish wherein a central vertical spar buoy is surrounded by one or more horizontal rim assemblies. A mesh/netting extends from an upper end portion of the spar buoy outward to the rim assemblies, and then inward from the rim assembly to a lower end portion of the spar buoy. See also, U.S. Pat. No. 9,072,282, to Madsen et al., which is hereby incorporated by reference. Madsen et al. discloses a spar buoy fish pen assembly with a deployable system for segregating a population of fish within a fish pen, and/or for crowding the fish into a smaller space, for example, to facilitate treatment or harvesting operations.

FIG. 1 illustrates a prior art open sea fish pen assembly 10 comprising a mesh enclosure 12 defining an enclosed volume for receiving and retaining fish and formed from a net material configured to retain the fish while permitting water flow therethrough. The mesh enclosure 12 is supported at its upper end by an annular floatation assembly 14. A ballast member, for example an annular weight ring 16, is suspended from the floatation assembly 14 with first cables 15. The weight ring 16 is typically also attached to a lower portion of the mesh enclosure 12 and configured to prevent the mesh enclosure 12 from collapsing, i.e., maintaining the mesh enclosure 12 in a full volume condition. A variable buoyancy chamber 18 provides means for raising and lowering the fish pen assembly 10, and includes an upper end 20 that is suspended from the weight ring 16 with a plurality of second cables 19. The variable buoyancy chamber 18 is closed at the upper end 20 and open (or partially open) at a bottom end 22. The variable buoyancy chamber 18 is functionally a bell jar that may be filled with air or water to change the buoyance of the fish pen assembly 10 between a positive buoyancy condition and a negative buoyancy condition. A lower ballast weight 26 is suspended from the variable buoyancy chamber 18 by a third cable 24, and may engage the seabed when the fish pen assembly 10 is submerged.

A buoyancy control system 30 may include an air source system 34, for example an air compressor located above the water, configured to controllably provide air to the variable buoyancy chamber 18 to increase buoyancy, and a control valve 32 to allow air to vent from the variable buoyancy chamber 18, which then fills with water. The buoyancy control system 30 is operatable to lower the fish pen assembly 10 by opening the valve 32 releasing air from the variable buoyancy chamber 18, or to raise or maintain the fish pen assembly 10 at the water surface by injecting or otherwise providing air into the variable buoyancy chamber 18.

Many fish have one or more internal swim bladders (also known as gas bladders, fish maws, or air bladders) having flexible walls that contract or expand in response to the ambient pressure. Swim bladders allow these fish to control their buoyancy, for example to obtain a neutral buoyancy, or to change swimming depth. Some fish with swim bladders include a connection between the swim bladder and the gut, allowing the fish to change the swim bladder contents at depth through a pneumatic duct, for example by “gulping” air (a physostomous swim bladder). But in some fish the swim bladder is not connected to the gut (a physoclist swim bladder), requiring these fish to rise to the surface to fill their swim bladder or to introduce gas through a process of diffing oxygen from the blood system into the swim bladder. Expelling gas from the swim bladder is accomplished through a structure known as the ‘oval window’, wherein the oxygen can diffuse back into the blood system. However, fish having physoclist swim bladders can be injured or killed by rising too fast, which can cause the swim bladders to burst.

The present invention relates to a submersible fish pen with a controllable ballast system having a multi-compartment ballast assembly that increases controllability when raising a fish pen from a submerged position towards the surface. A disadvantage of prior art system is that controlling the rate of ascent of the fish pen assembly 10 from a submerged position can be problematic. As air is injected into the variable buoyancy chamber 18, when sufficient air has been injected the fish pen assembly 10 begins to rise. The local hydrostatic pressure decreases as the fish pen assembly 10 rises causing air in the variable buoyancy chamber 18 to expand, further increasing the buoyance of the fish pen assembly 10. Therefore the vertical speed of the fish pen assembly 10 will increase as the fish pen assembly 10 rises. It would be beneficial to provide a fish pen with a variable buoyancy chamber that is configured to reduce the tendency of the fish pen assembly to accelerate when it is rising toward a surfaced position.

In addition, prior art variable buoyancy chambers 18 are suspended by a cable attached to an upper end of the variable buoyancy chamber 18, as illustrated in FIG. 1 such that the variable buoyancy chamber 18 extends downwardly a distance from the fish pen. Therefore, in prior art systems, the fish pen assembly 10 must be in relatively deep waters to be able to fully submerge. It would be a benefit to provide a variable buoyancy chamber that would permit the fish pen to be fully submerged in shallower waters.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an embodiment of the invention a submersible aquaculture pen is disclosed that includes a mesh enclosure supported in the water by an annular floatation collar attached to an upper end of the mesh enclosure. A weight ring is also suspended from the floatation collar, for example, using a plurality of cables. A variable buoyancy assembly that includes a plurality of connected bell jars is suspended below the mesh enclosure with a second plurality of cables or other tension members. To raise the aquaculture pen from a submerged position, an air supply system is configured to inject a metered quantity of air into each of the connected bell jars to initiate surfacing the aquaculture pen.

In an embodiment the plurality of bell jars includes at least three bell jars.

In an embodiment the variable buoyancy assembly is a circular cylinder formed cooperatively by the plurality of bell jars.

In an embodiment the plurality of bell jars are at least three connected tubes arranged in parallel.

In an embodiment the air supply system includes a compressor and a plurality of control valves that are configured to deliver air from the compressor to a corresponding one of the plurality of bell jars.

In an embodiment the variable buoyancy assembly includes a collar disposed in a central portion of the variable buoyancy assembly, and the second plurality of cables that support the variable buoyancy assembly extend between the collar and the variable buoyancy assembly.

In an embodiment the submersible aquaculture pen includes a ballast member that is suspended from the variable buoyancy assembly.

A variable buoyancy device for a submersible aquaculture pen is disclosed that includes a plurality of connected bell jars that are closed at a top and have an opening at a bottom end.

In an embodiment the variable buoyancy device has at least three connected bell jars.

In an embodiment the at least three connected bell jars are arranged to cooperatively define a right circular cylinder.

In an embodiment the at least three connected bell jars are elongate bell jars arranged adjacent and parallel to each other.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a prior art submersible fish pen having an elongate variable buoyancy chamber for controlling the buoyance of the fish pen assembly to move the fish pen assembly between a submerged position and a surfaced position, wherein the variable buoyancy chamber is suspended by cables that engage a top end of the floatation device;

FIG. 2 shows a submersible fish pen in accordance with the present invention having a variable buoyancy assembly characterized by three contiguous bell jars, wherein the variable buoyancy assembly is suspended from cables that engage the variable buoyancy assembly from an intermediate location along the length of the variable buoyancy assembly;

FIGS. 3A-3C illustrate an example of the water levels in each of the three contiguous bell jars at three different times as the fish pen assembly shown in FIG. 2 is raised from a submerged position to the water surface; and

FIG. 4 illustrates a variable buoyancy assembly having three contiguous bell jars similar to the system shown in FIG. 2, but wherein the three bell jars are relatively elongate and narrow tubes that are disposed in parallel.

### DETAILED DESCRIPTION

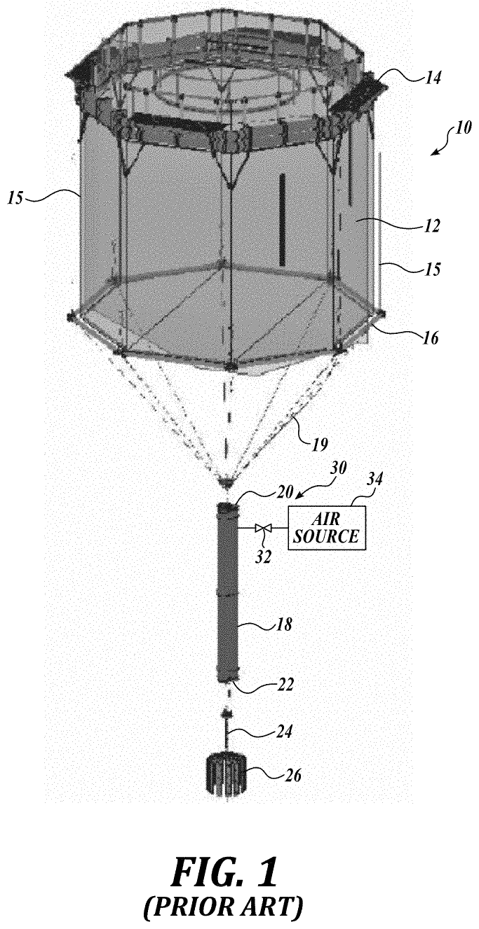

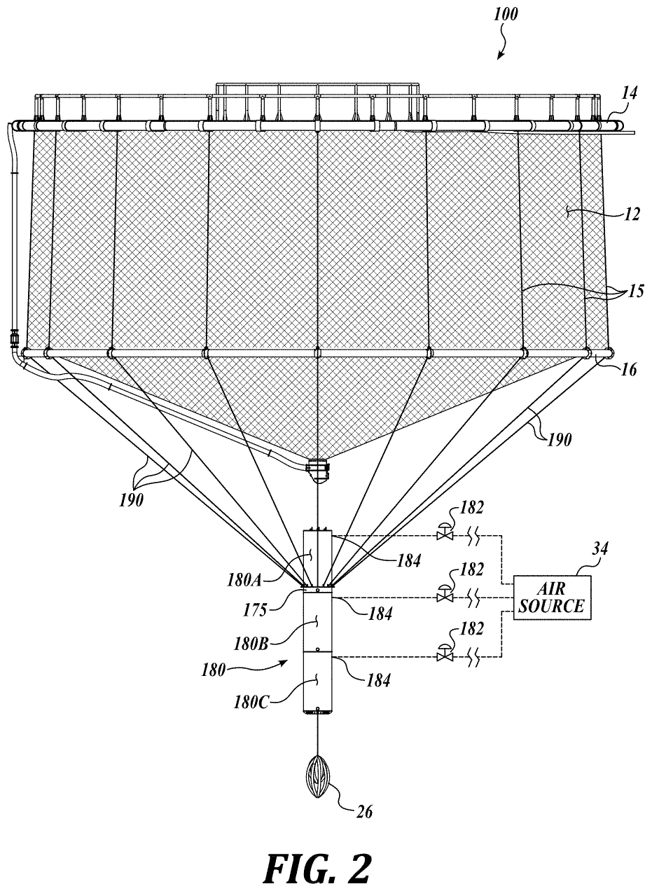

A submersible open sea fish pen assembly 100 in accordance with the present invention is shown in FIG. 2, wherein the fish enclosure is similar to the fish pen assembly 10 shown in FIG. 1. In particular, the fish pen assembly 100 includes a mesh enclosure 12 defining an enclosed volume providing a fish habitat, a floatation assembly 14 attached to an upper portion of the mesh enclosure 12, and a weight ring 16 suspended by a plurality of cables or other tension members 15 from the floatation assembly 14, as described in more detail above.

An elongate, multi-chamber variable buoyancy assembly 180 is suspended from the weight ring 16 with a plurality of cables 190 that engage a peripheral attachment collar 175 disposed in a central location along the length of the variable buoyancy assembly 180. For example, in a current embodiment the attachment collar 175 is located on a middle section of the variable buoyancy assembly 180, for example, within a central one-third of the length of the variable buoyancy assembly 180. The attachment collar 175 may be integral with the variable buoyancy assembly 180 or separately attached to the variable buoyancy assembly 180. The central location of the attachment collar 175 between opposite ends of the variable buoyancy assembly 180 allows the fish pen assembly 100 to fully submerge in relatively shallower water than the prior art variable buoyancy assembly 18 shown in FIG. 1.

The variable buoyancy assembly 180 in this embodiment comprises three contiguous bell jars 180A, 180B, 180C, wherein “bell jar” is herein defined conventionally as a structure defining a volume that is closed at a top end and open (at least partially) at a bottom end. Optionally, a lower ballast member 26 is suspended from a bottom end of the lower bell jar 180C and configured to engage the sea floor in sufficiently shallow water to prevent the variable buoyancy assembly 180 from impacting the sea floor.

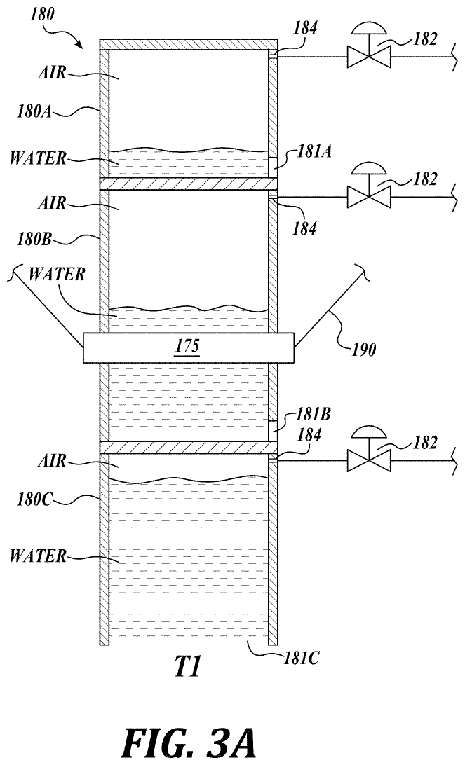

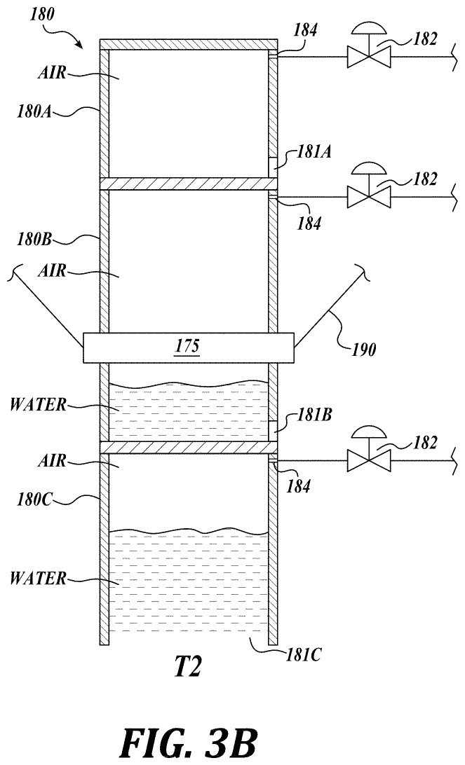

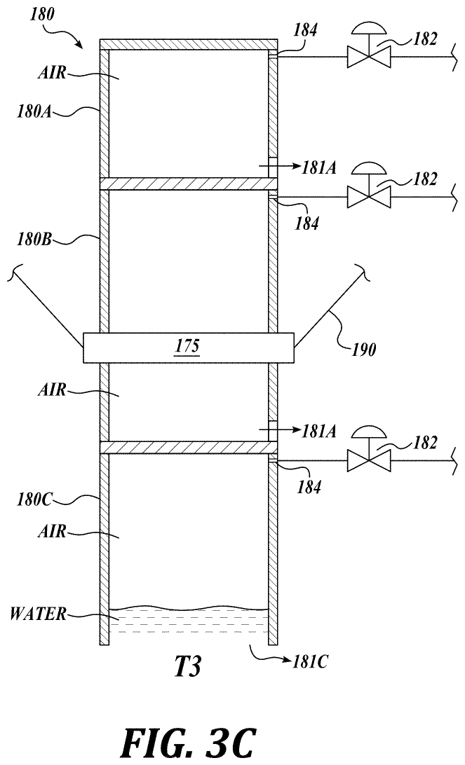

Each bell jar 180A, 180B, 180C includes a corresponding port 184 near an upper end of the bell jar that is connected to a source of air 34, for example a pump or compressed air system disposed above the waterline, through a corresponding control valve 182, such that air may be independently injected into the respective bell jars 180A, 180B, 180C. The bell jars 180A, 180B, 180C are open, or partially open, at respective lower ends of the bell jars through openings 181A, 181B, 181C, respectively (see FIG. 3A).

In operation, to submerge the fish pen assembly 100 the control valves 182 are opened to permit the release of air from the bell jars 180A, 180B, 180C until the fish pen assembly 100 achieves a net negative buoyancy. The fish pen assembly 100 will then submerge, for example until the lower ballast member 26 engages a sea floor, thereby reducing the weight that is supported by the floatation assembly 14. To raise the fish pen assembly 100 to the water surface, a gas, typically air, is injected into the bell jars 180A, 180B, 180C until the submerged fish pen assembly 100 achieves a net positive buoyancy. As the fish pen assembly 100 rises, the air in the bell jars 180A, 180B, 180C will continue to expand due to the decreasing hydrostatic pressure. In prior art systems the progressive expansion of the air increases the buoyancy of the fish pen assembly 100 continuously, which may result in the fish pen assembly rising too quickly. As discussed above, rising too fast may be harmful to fish in the fish pen. The novel multi-segment variable buoyancy assembly 180 allows some of the air to automatically vent from the variable buoyancy assembly while it is rising, reducing the dangers associated with a too-rapid ascent.

Refer now to FIGS. 3A, 3B, and 3C showing diagrammatically the variable buoyancy assembly 180 at three sequential times indicated as T1, T2, and T3 during an ascent of the fish pen assembly 100. Although the bell jars 180A, 180B, 180C in this embodiment have different volumes, it is contemplated that in other embodiments the bell jars forming the variable buoyancy assembly 180 may have the same volume and the variable buoyancy assembly 180 may comprise more or fewer than three bell jars.

At time T1 the fish pen assembly 100 is submerged and the bell jars 180A, 180B, 180C have received a predetermined quantity of air to initiate raising the fish pen assembly 100. In this example, the first bell jar 180A received sufficient air to displace most of the water in the first bell jar 180A (injection of the air causing the water to be ejected through opening 181A), the second bell jar 180B received sufficient air to displace approximately half of the water in the second bell jar 180B (the water ejected through opening 181B), and the third bell jar 180C received sufficient air to displace a relatively small portion of the water in the third bell jar 180C (the water ejected through the open bottom 181C of the third bell jar).

Referring to FIG. 3B, at time T2 the fish pen assembly 100 has risen a distance. As the fish pen assembly 100 rises the air in the bell jars 180A, 180B, 180C continues to expand due to decreasing external pressure. In this example all of the water in the first bell jar 180A has been ejected and therefore as the fish pen assembly 100 continues to rise the buoyancy force generated by the first bell jar 180A will no longer increase because the expanding air in the first bell jar 180A no longer displaces additional water. However, the expanding air in the second and third bell jars 180B, 180C continue to displace water and therefore the net buoyancy increases, albeit at a slower rate.

At time T3 the fish pen assembly 100 has risen a further distance in the water, and the air in the second bell jar 180B has expelled all of the water in the second bell jar 180B. Therefore, as the fish pen assembly 100 continues to rise the buoyancy provided from the second bell jar 180B will not increase. However, the expanding air in the third bell jar 180C will continue to displace water and increase the buoyancy until the water therein has been expelled. After all of the water is displaced from the third bell jar 180C, the buoyancy of the system will not increase further as the fish pen rises in the body of water.

Therefore, the variable buoyancy assembly having a plurality of separate bell jars 180A, 180B, 180C, will automatically reduce the tendency of a fish pen assembly to accelerate during the surfacing process.

The multi-chamber variable buoyancy assembly 180 with a plurality of bell jars 180A, 180B, 180C allows an operator to raise a fish pen from a submerged location to a surfaced position by providing a predetermined amount of gas, e.g., air, to each of the plurality of bell jars, such that the tendency of the fish pen to accelerate during the rising operation is reduced.

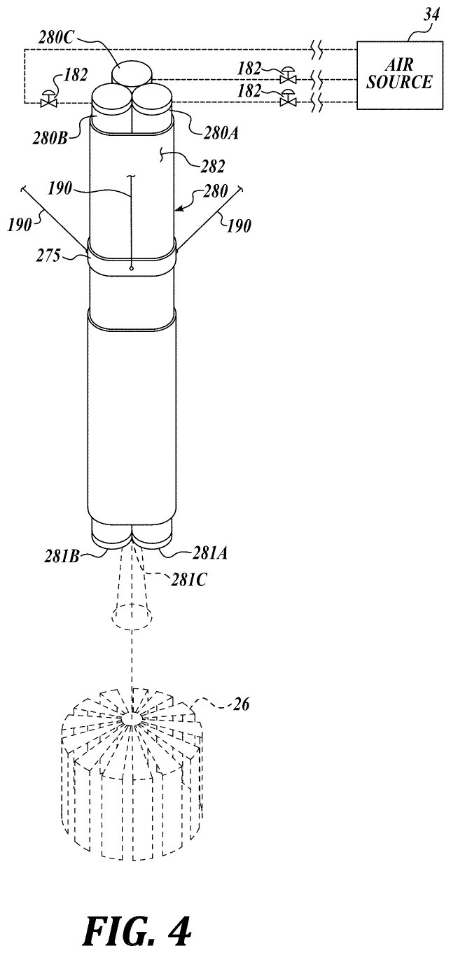

A second embodiment of a variable buoyancy assembly 280 in accordance with the present invention is shown in FIG. 4, which is similar to the variable buoyancy assembly 180 described above, except that the plurality of bell jars 280A, 280B, 280C are relatively long and narrow adjacent tubular members extending downwardly in parallel alignment from a top end of variable buoyancy assembly 280. Each of the plurality of bell jars 280A, 280B, 280C are independently connected to a source of air 34 through a port at their upper ends and are lower at their lower ends 281A, 281B, 281C. The variable buoyancy assembly 280 is suspended from the weight ring 16 with a plurality of cables 190, as described above.

It will now be appreciated that when the fish pen is to be raised from a submerged position, the bell jars 280A, 280B, 280C may each be provided with a predetermined quantity of air from the air source 34. In particular, the bell jars 280A, 280B, 280C may be provided different quantities of air such that as the fish pen rises, bell jar 280A may displace all of its water at a relatively low elevation, such that bell jar 280A will no longer increase in buoyancy as the fish pen continues to rise.

While illustrative embodiments have been illustrated and described, it will be appreciated that various changes can be made therein without departing from the spirit and scope of the invention.

The embodiments of the invention in which an exclusive property or privilege is claimed are defined as follows:

1. A submersible aquaculture pen comprising:
a mesh enclosure;
an annular floatation collar attached to an upper end of the mesh enclosure, wherein the floatation collar is configured to support the mesh enclosure in the body of water;
a weight ring suspended from the floatation collar with a first plurality of cables;
a variable buoyancy assembly comprising a plurality of connected bell jars that are closed at a top end and have an opening at a bottom end, wherein the variable buoyancy assembly is connected to the weight ring with a second plurality of cables; and
an air supply system configured to selectively inject air into each of the connected bell jars, wherein the amount of air injected into each bell jar is controllable.

2. The submersible aquaculture pen of claim 1, wherein the plurality of bell jars comprises at least three bell jars.

3. The submersible aquaculture pen of claim 1, wherein the plurality of bell jars cooperatively define a circular cylinder.

4. The submersible aquaculture pen of claim 1, wherein the plurality of bell jars comprises at least three tubes arranged in parallel.

5. The submersible aquaculture pen of claim 1, wherein the air supply system comprises a compressor and a plurality of control valves, wherein each control valve is configured to deliver air from the compressor to a corresponding one of the plurality of bell jars.

6. The submersible aquaculture pen of claim 1, wherein the variable buoyancy assembly further comprises a collar disposed in a central portion of the variable buoyancy assembly, and wherein the second plurality of cables that support the variable buoyancy assembly extend between the collar and the variable buoyancy assembly.

7. The submersible aquaculture pen of claim 1, further comprising a ballast member that is suspended from the variable buoyancy assembly.

8. A variable buoyancy device for a submersible aquaculture pen, the variable buoyancy device comprising a plurality of connected bell jars that are closed at a top and have an opening at a bottom end.

9. The variable buoyancy device of claim 8, wherein the variable buoyancy device comprises at least three connected bell jars.

10. The variable buoyancy device of claim 9, wherein the at least three connected bell jars are arranged to cooperatively define a right circular cylinder.

11. The variable buoyancy device of claim 9, wherein the at least three connected bell jars comprise elongate bell jars arranged adjacent and parallel to each other.
